(19) United States
(12) Patent Application Publication
(10) Pub. No.: US 2015/0199262 A1
(43) Pub. Date: Jul. 16, 2015

(54) RUNTIME CODE VISUALIZATION

(71) Applicants: Vivek Bhavsar, Pune (IN); Dheren Gala, Pune (IN); Ankit Sharma, Pune (IN); Chaitanya Gottipati, Hyderabad (IN)

(72) Inventors: Vivek Bhavsar, Pune (IN); Dheren Gala, Pune (IN); Ankit Sharma, Pune (IN); Chaitanya Gottipati, Hyderabad (IN)

(21) Appl. No.: 14/157,016

(22) Filed: Jan. 16, 2014

(51) Int. Cl. G06F 11/36

(52) U.S. Cl. CPC G06F 11/3664

(57) ABSTRACT

Disclosed herein are system, method, and computer program product embodiments for visualizing code execution of a multi-threaded server. An embodiment operates by receiving a log of contents of a plurality of thread stacks over a time period of code execution and receiving a rule for populating a graphical interface with thread stack contents. It also includes populating the graphical interface with a representation of the thread stack contents over time.

### BACKGROUND

In software development, detecting inefficiencies in parallel code can be a difficult task. Software programmers generally rely on code path execution analysis tools to detect conditions and patterns such as deadlocks, serializations and inter-thread dependencies. However, existing tools do not provide an effective way of visualizing thread execution that can help programmers understand what happens inside a multi-threaded server, or provide insightful analysis of performance issues.

### BRIEF DESCRIPTION OF THE DRAWINGS

The accompanying drawings are incorporated herein and form a part of the specification.

FIG. 1 is a block diagram of an operating environment for a graphical code execution stack visualizer, according to an example embodiment.

FIG. 2 is a graphical user interface (GUI) for visualizing executed code stack traces, according to an example embodiment.

FIG. 3 is a GUI for loading a stack trace profile into a visualizer GUI, according to an example embodiment.

FIG. 4 is a GUI for creating visualization rules for a stack trace timeline chart, according to an example embodiment.

FIG. 5 is a stack trace visualizer GUI with a rule as created in the example depicted on FIG. 4, according to an example embodiment.

FIG. 6 is a further example stack trace visualizer GUI, according to an example embodiment.

FIG. 7 is a flowchart of a method for visualizing code execution of a multi-threaded server, according to an example embodiment.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for visualizing code execution of a multi-threaded server.

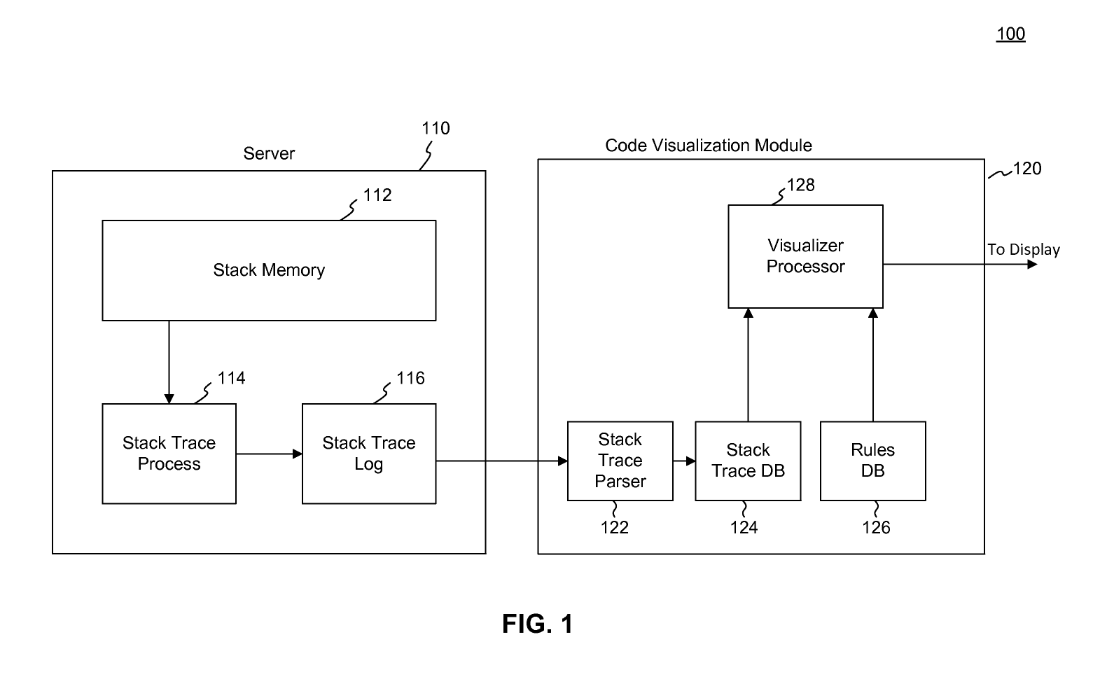

FIG. 1 is a block diagram of an operating environment 100 for a graphical code execution stack visualizer, according to an example embodiment.

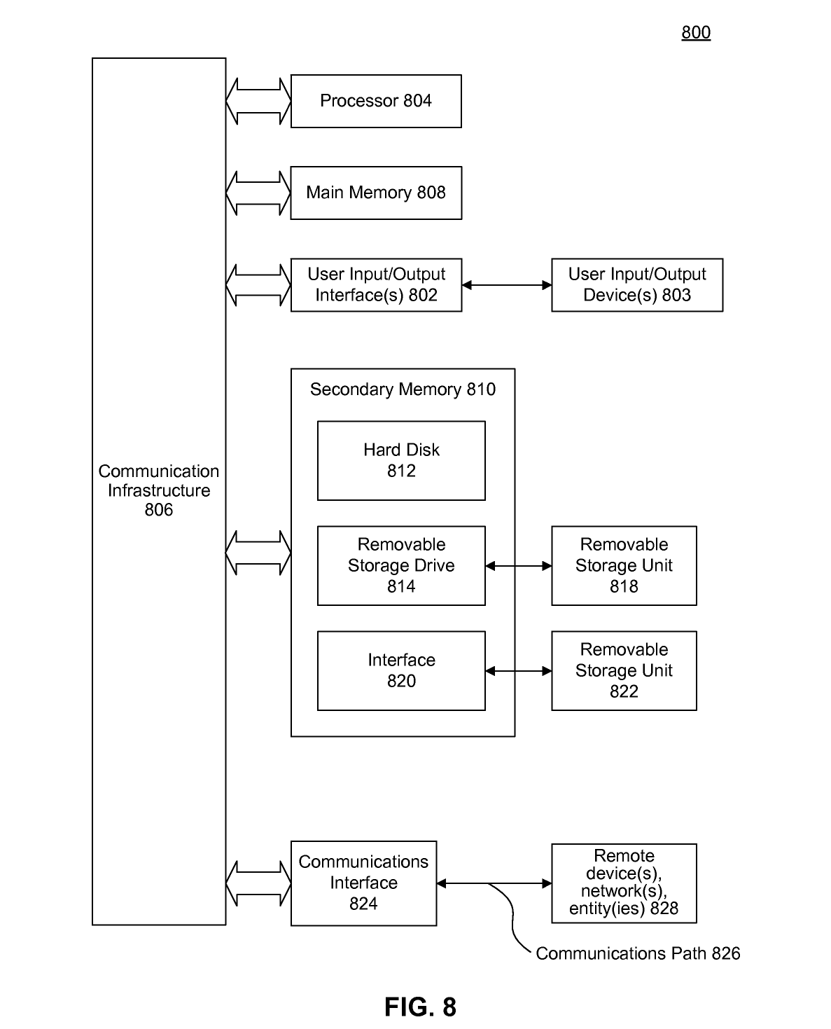

In an embodiment, environment 100 includes a server 110, code visualizer 120, and a network 130. Server 110 can run multi-threaded server applications. Server 110 can be hosted by a computing device, for example, as described with reference to FIG. 8 below. Code visualizer 120 can be used to graphically display the code execution states of threads running in server 110. Code visualizer 120 can be hosted on the same or a separate computing device as server 110. In an embodiment, code visualizer 120 is hosted in a client machine that connects to server 110 through a network 130, and displays the code execution states in a client machine display.

Network 130 can be any data communications network, such as, for example, a local area network (LAN), a wide area network (WAN), a wireless network, the Internet, etc.

Server 110 can include a stack memory 112, a stack trace process 114 and a stack trace log 116. Stack memory 112 can contain the stacks of threads running in server 110.

Stack trace process 114 can record the contents of stacks in stack memory 112 over time. For example, stack trace process 114 can record the state and the functions and calls executed by threads running in the server 110 over time. These contents are henceforth referred to as a stack trace. Stack trace process 114 can run on server 110 and output the stack traces and store them in stack trace log 116. In an embodiment, stack trace process 114 samples thread states periodically, for example, at predetermined time intervals. In an embodiment, stack trace process 114 can be based on stack monitoring utilities, such as, but not limited to pstack and sybmon.

Code visualizer 120 can include a stack trace parser 122, a stack trace database 124, a rules database 126, and a visualizer 128.

Stack trace parser 122 can parse a stack trace log 116 to generate a stack trace database 124. In an embodiment, stack trace parser 122 is a script executable on a client computer. In an embodiment, stack trace parser 122 is implemented in a scripting language.

Stack trace database 124 can be a database that can be queried using an information retrieval query language. Storing the stack trace information in a database format can allow the visualizer 128 to obtain information based on rules. In an embodiment, stack trace database 124 is a sqlite database, which is a software library for implementing databases, but is not limited to these examples.

Visualizer 128 can generate a graphical user interface (GUI) and populate the GUI with stack information. Rules database (DB) 12 can contain rules that specify what stack information to use to populate the GUI and in what format the GUI should use to display the information. The rules can be configurable and/or user (e.g., system administrator) defined. In an embodiment, rules specify that portions of the stack, which meet certain conditions, should be displayed using a particular identifier (e.g., color). For example, the rules may specify that portions of the stack where a particular function is executing should be displayed in a particular color.

Visualizer 128 can fetch rules and instructions, received from user input, and query the stack trace database 124 for stack trace information. The rules and instructions can specify identifiers for displaying stack trace information. Visualizer 128 can generate a graphical user interface (GUI) and populate the GUI with the stack information, as further explained below.

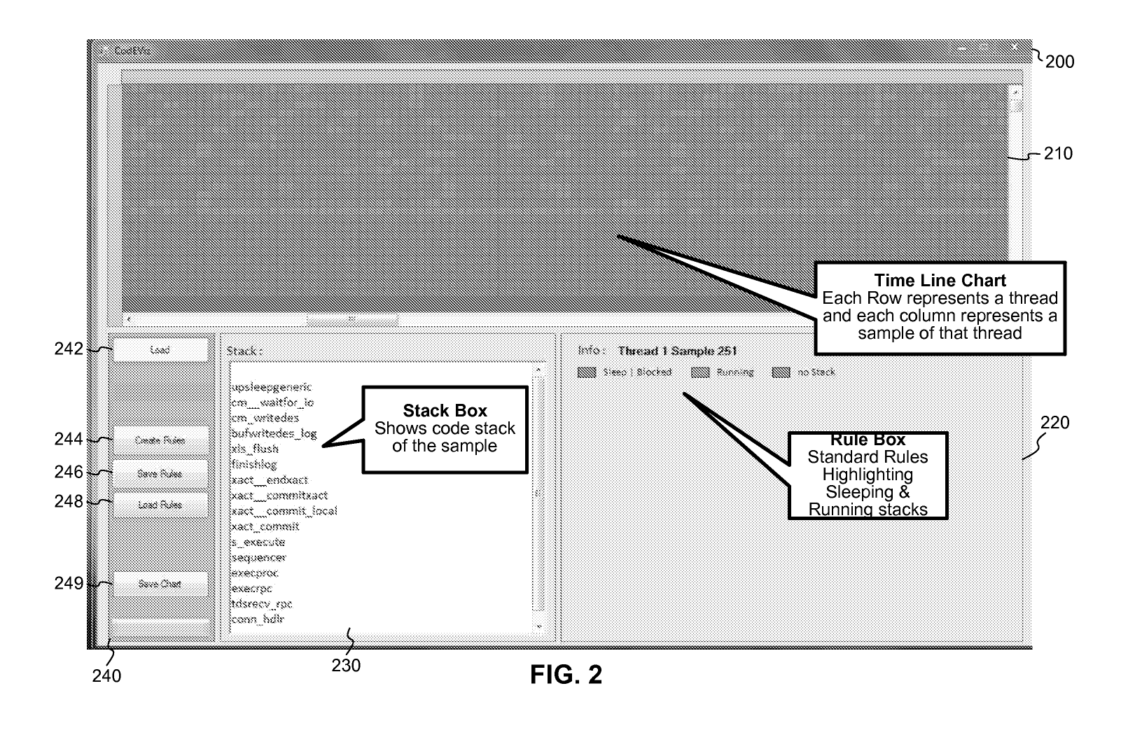

FIG. 2 is a graphical user interface (GUI) 200 for visualizing executed code stacks, according to an example embodiment. Visualizer 128 can generate GUI 200 and may provide GUI 200 via a display, for example, of a client computer communicating with a server (e.g., server 110 in FIG. 1),

Visualizer GUI 200 can include one or more of a timeline chart region 210, a rules box region 220, a stack box region 230, and/or an options menu region 240.

The timeline chart region 210 can include GUI 200 elements to graphically depict the states of server threads, for example, using a plot timeline. The GUI 200 elements can include, for example, and are not limited to, rows, columns, lines, bars, etc. For example, timeline chart region 210 may include rows and cells. For example, each row in timeline chart region 210 can represent a thread and each column can represent a sample of the state of that thread. In an embodiment, threads are sorted based on activity. For example, the more active threads may be positioned higher in the timeline chart region 210. Each thread sample that is represented, for example, using cells in the timeline chart region 210, can be represented with a different color depending on the state. The states of the threads can be identified using one or more GUI 200 elements. The GUI 200 elements can include, for example, and are not limited to, colors, patterns, line styles, etc. For example, timeline chart region 210 may include color identifiers. Although FIG. 2 is shown in grayscale, the color for the states may be illustrated in rules box region 220. Visualizer 128 can generate timeline chart region 210 based on data from stack trace database 124 and rules from rules database 126.

Rules box 220 can include a list of rules with an associated color legend for the display of states in timeline chart region 210. In the example shown in FIG. 2, rules box 220 lists three rules: “Sleep|Blocked,” “Running,” and “no Stack.” Each rule may have an associated color, and the states of the samples of threads that meet the rules can be colored accordingly. In this example, threads that are running may be depicted in one color, while threads that are sleeping may be depicted in a different color. In an embodiment, the rules are default rules that are displayed. Additional rules can be created in addition to the default rules based on user input. In an embodiment, when a selection of a sample thread is made, for example from user input received via the GUI 200, the sample thread identifier and sample number are displayed, as shown in rules box 220 (“Thread 1 Sample 251”). The sample number can correspond to one of the sample states for the sample thread.

Stack box 230 can include a list of the contents of the stack at a particular sample time selected by a user via the GUI 200. In the example depicted in FIG. 2, at the time of sample 251 for Thread 1, the stack contained the contents as shown in stack box 230.

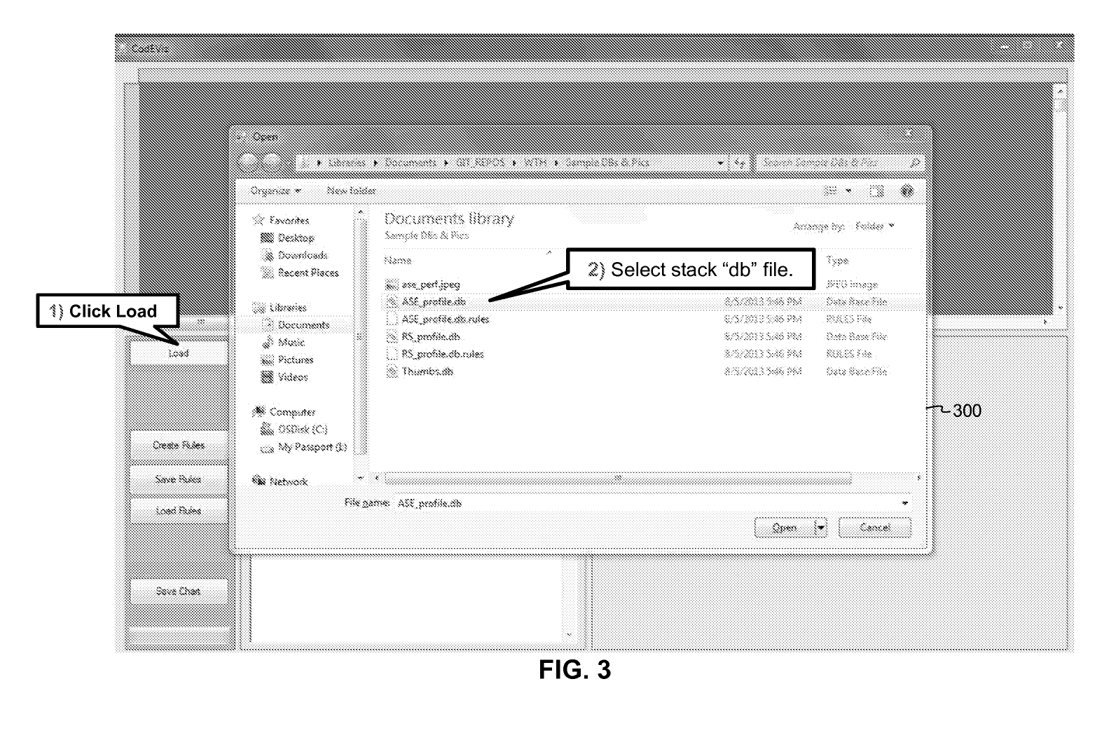

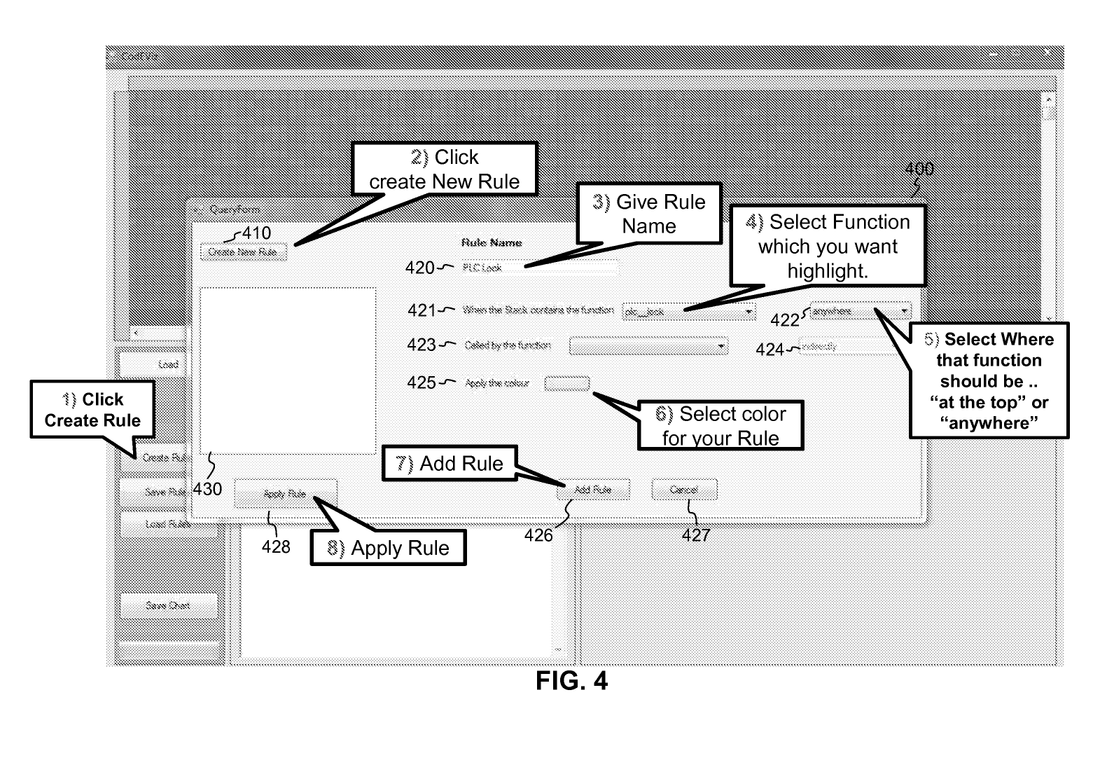

Options menu region 240 can include one or more GUI 200 elements for options to create information via GUI 200, load information into GUI 200, and save information from GUI 200. For example, options menu region 240 can include a Load stack profile option 242, Create Rules option 244, Save Rules option 246, Load Rules option 248, and Save Chart option 249. Load stack profile option 242 can load a stack trace database generated by stack trace parser 122 for visualization, as further explained below with reference to FIG. 3. The loading of a stack trace database can be based on user input. Create Rules option 244 can specify rules for visualizing contents of the loaded stack, as further explained below with reference to FIG. 4. The specifying of the rules can be based on user input. Save Rules option 246 can save specified rules to rules database 126. The rules to be saved can be based on user input. Load Rules option 248 can load rules from rules database 126, for example, based on user input. Save Chart option 249 can save the depicted timeline chart.

FIG. 3 is a GUI 300 for loading a stack trace profile into visualizer GUI 200, according to an example embodiment. In an embodiment, a stack trace database 124 is stored as a database file. Visualizer 128 can generate one or more GUIs (e.g., GUI 300), for example, in response to receiving user input and may provide the GUIs via a display, for example, of a client computer communicating with a server (e.g., server 110 in FIG. 1). The GUI 200 can receive user input for loading a stack profile into the visualizer GUI 200. For example, a user may select a stack trace database file for loading by selecting the Load stack profile option 242 on GUI 200 and the visualizer 128 may generate GUI 300 in response to receiving the user input of the user selection. A user may select a file on GUI 300. The stack trace database is then loaded and the GUI 200 can be populated with the selected stack trace information as described above.

FIG. 4 is a GUI 400 for creating visualization rules for a stack trace timeline chart, according to an example embodiment. Visualizer 128 can generate one or more GUIs (e.g., GUI 400), for example, in response to receiving user input and may provide the GUIs via a display, for example, of a client computer communicating with a server (e.g., server 110 in FIG. 1).

For example, visualizer 128 can generate GUI 400 in response to receiving user input of a user selecting the Create Rules option 244 in GUI 200. In an embodiment, user input of a user selecting Create New Rule 410 option in GUI 400 can be received to create a new rale by using options 420-426. A rule can apply a particular identifier (e.g., color) to stack samples for which certain conditions are met.

User input of the name for the rule can be received. For example, a user may enter a name for the rule in box 420. A GUI (e.g., GUI 400) can include input elements, such as and not limited to, a text box and a pull-down menu for receiving user input.

For example, user input can be received, via a function Box 421, that specifies a function that should trigger the rule to apply the identifier (e.g., color) to the stack sample when the function is present in the stack. A GUI element, such as Function Location Box 422, which may be a pull-down menu, can receive user input specifying whether the functions should appear at the top of the stack or be positioned elsewhere in the stack.

User input that specifies a second function can be received via a GUI 400 element, such as Called By Box 423. The second function can call the function in Function Box 421 such that the rule is satisfied. User input that specifies whether the call was direct or indirect can be received via a GUI 400 element, such as Call Type Box 424.

User input that specifies an identifier (e.g., color) for the rule can be received via a GUI 400 element, such as Color Box 425. The user may select Add Rule option 426 to add the rule to the Rule List 430, and may select Apply Rule option 428 to apply a rule from the Rule List 430 to the stack timeline chart.

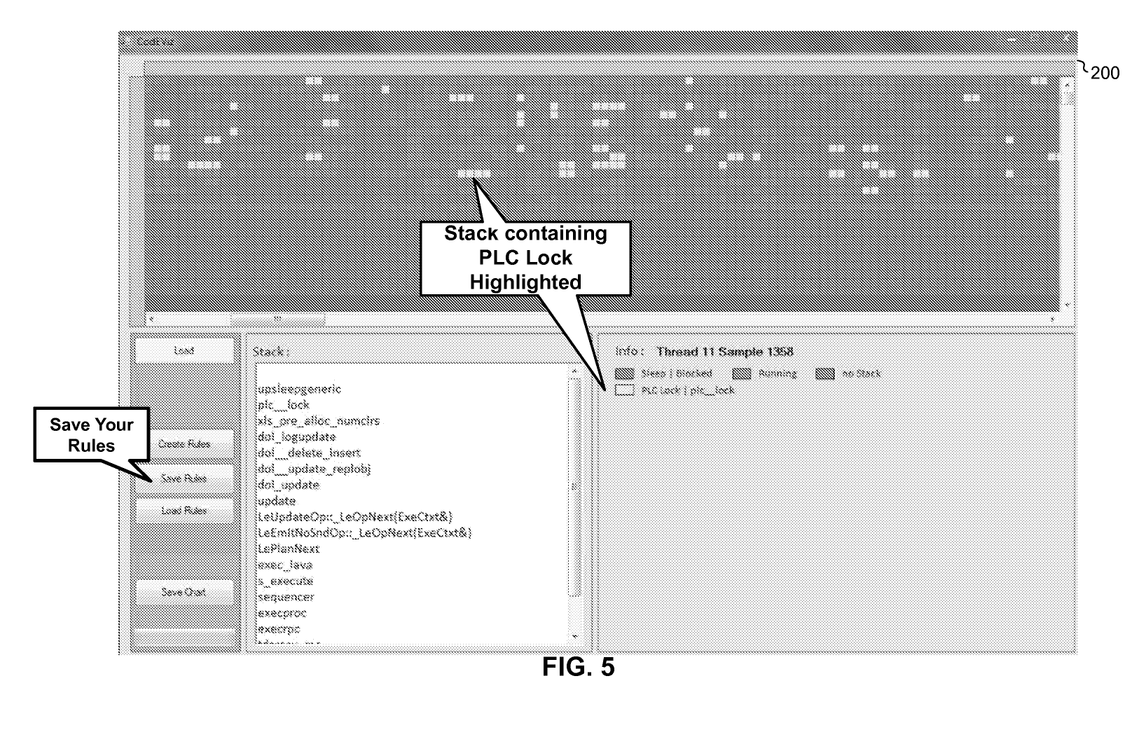

FIG. 5 depicts GUI 200 with a rule as created in the example depicted on FIG. 4, according to an example embodiment.

When rules are applied as described above with reference to FIG. 4, visualizer 128 can generate a timeline chart region by evaluating the rules against the data in stack trace database 124. In an embodiment, visualizer 128 evaluates the rules by searching stack trace database 124 for samples that match the rules criteria. For example, visualizer 128 can run a database query to obtain the samples that meet the search criteria, as will be understood by those skilled in the relevant arts.

For example, sample 510 may have the same color associated with rule “PLC Lock,” as illustrated in FIG. 5. Created rules can be saved using Save Rules option 236, and loaded using Load Rules option 238.

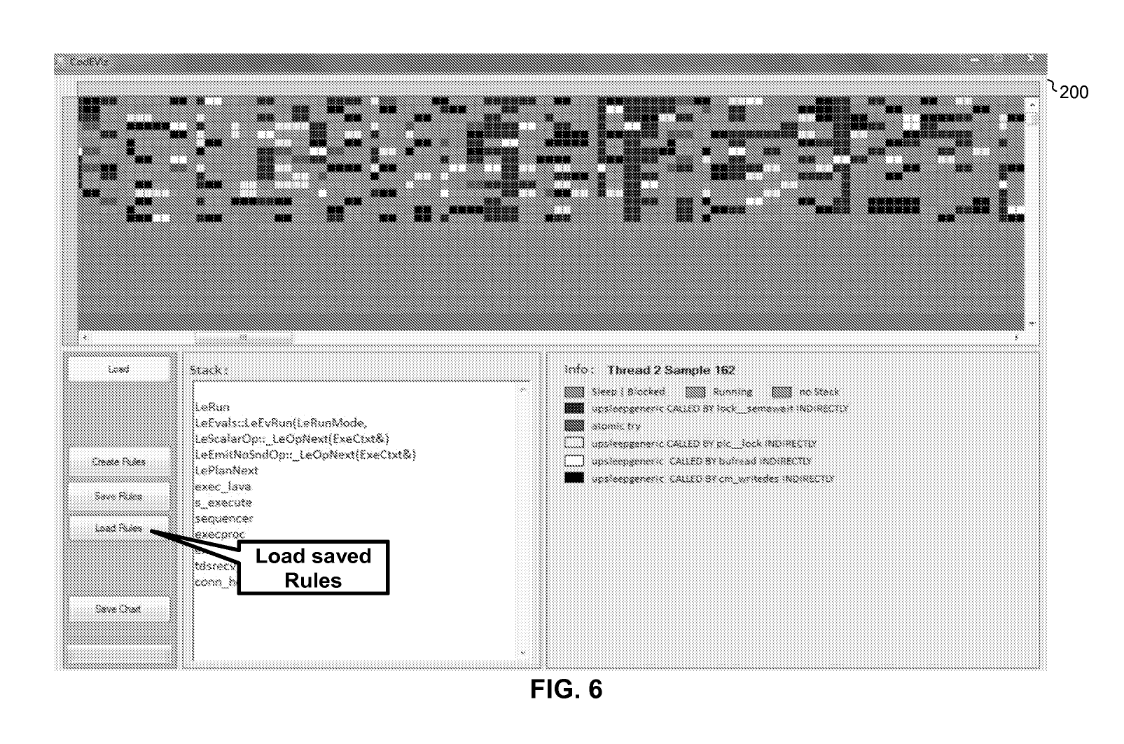

FIG. 6 depicts a further example of stack trace visualizer GUI including a stack timeline region and evaluated rules, according to an example embodiment. As depicted in FIG. 6, multiple rules can be created and displayed.

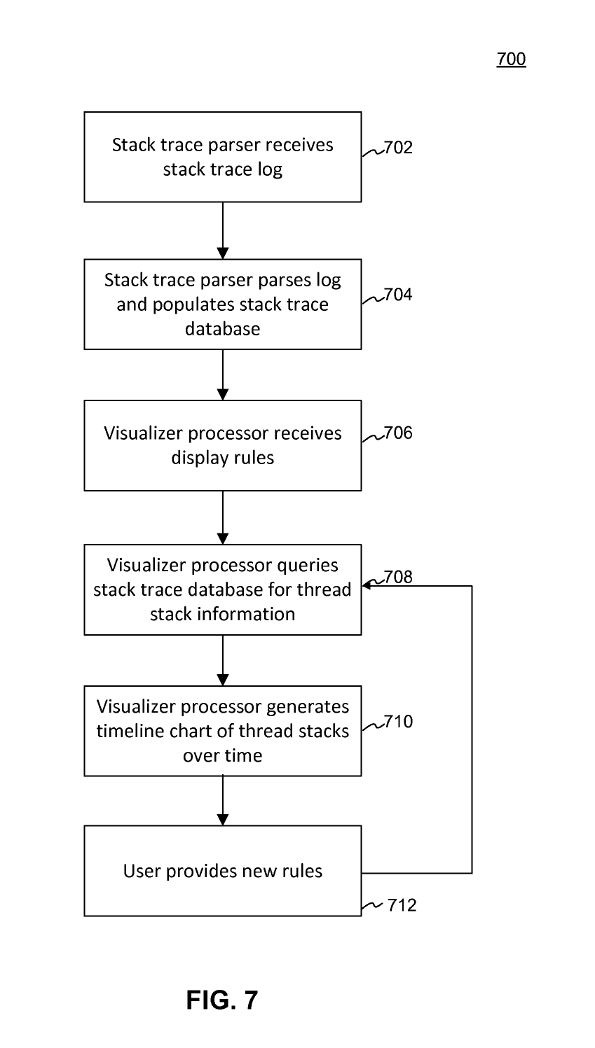

FIG. 7 is a flowchart of a method for visualizing code execution of a multi-threaded server, according to an example embodiment.

At operation 702, the code visualizer receives a stack trace log containing traces of thread stacks over a period of code execution time.

At operation 704, the code visualizer parses the stack trace log and populates a stack trace database 124 with the stack traces for threads.

At operation 706, the code visualizer receives rules for displaying the stack contents in a timeline chart region in a GUI.

At operation 708, the code visualizer queries stack trace database 124 for stack trace information.

At operation 710, the code visualizer generates the timeline chart region of the stacks in the GUI by populating the GUI with the stacks of the threads using identifiers (e.g., colors, patterns) for different states, as previously described by way of example. Furthermore, the code visualizer can apply identifiers (e.g., colors, patterns) to a subset of the states based on the rules, as previously described by way of example.

Various embodiments can be implemented, for example, using one or more well-known computer systems, such as computer system 800 shown in FIG. 8. Computer system 800 can be any well-known computer capable of performing the functions described herein, such as computers available from International Business Machines, Apple, Sun, HP, Dell, Sony, Toshiba, etc.

Computer system 800 includes one or more processors (also called central processing units, or CPUs), such as a processor 804. Processor 804 is connected to a communication infrastructure or bus 806.

One or more processors 804 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 800 also includes user input/output device(s) 803, such as monitors, keyboards, pointing devices, etc., which communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible apparatus or article of manufacture comprising a tangible computer useable or readable medium having control logic (software) stored. thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 8. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof The boundaries of these functional building blocks have been arbitrarily defined herein for the convenience of the description. Alternate boundaries can be defined as long as the specified functions and relationships (Or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer implemented method, comprising:
receiving, by at least one processor, a log of contents of a plurality of thread stacks over a time period of code execution;
receiving, by the at least one processor, a rule for populating a graphical interface with thread stack contents; and
populating, by the at least one processor, the graphical interface with a representation of the thread stack contents over time,
wherein the representation comprises different identifiers for different thread stack contents and the graphical interface comprises a representation of a subset of the thread stack contents based on the rule.

2. The method of claim 1, wherein the different thread stack contents comprise data for at least one of a running thread or a sleeping thread and wherein the different identifiers comprise different colors.

3. The method of claim 1, wherein the rule specifies an identifier for displaying the thread stack contents.

4. The method of claim 1, wherein the rule specifies a first function and an identifier to be applied when the thread stack contents contain the first function.

5. The method of claim 4, wherein the rule specifies the identifier is to be applied when the first function is at a top of the stack.

6. The method of claim 4, wherein the rule specifies a second function and that the identifier is to be applied when the first function is called by the second function.

7. A system, comprising:
a memory; and
at least one processor coupled to the memory and configured to:
receive a log of contents of a plurality of thread stacks over a time period of code execution; and
receive a rule for populating a graphical interface with thread stack contents; and
populating the graphical interface with a representation of the thread stack contents over time,
wherein the representation comprises different identifiers for different thread stack contents and the graphical interface comprises displaying a representation of a subset of the thread stack contents based on the rule.

8. The system of claim 7, wherein the different thread stack contents comprise data for at least one of a running thread or a sleeping thread and wherein the different identifiers comprise different colors.

9. The system of claim 7, wherein the rule specifies an identifier for displaying the thread stack contents.

10. The system of claim 7, wherein the rule specifies a first function and an identifier to be applied when the thread stack contents contain the first function.

11. The system of claim 10, wherein the rule specifies the identifier is to be applied when the first function is at a top of the stack.

12. The system of claim 10, wherein the rule specifies a second function and that the identifier is to be applied when the first function is called by the second function.

13. A tangible computer-readable device having instructions stored thereon that, when executed by at least one computing device, causes the at least one computing device to perform operations comprising:
receiving a log of contents of a plurality of thread stacks over a time period of code execution; and
receiving a rule for populating a graphical interface with thread Stack contents; and
populating the graphical interface with a representation of the thread stack contents over time,
wherein the representation comprises different identifiers for different thread stack contents and the graphical interface comprises a representation of a subset of the thread stack contents based on the rule.

14. The computer-readable device of claim 13, wherein the different thread stack contents comprise data for at least one of a running thread or a sleeping thread and wherein the different identifiers comprise different colors.

15. The computer-readable device of claim 13, wherein the rule specifies an identifier for displaying the thread stack contents.

16. The computer-readable device of claim 15, wherein the rule specifies a first function and an identifier to be applied to the colored representation when the thread stack contents contain the first function.

17. The computer-readable device of claim 15, wherein the rule specifies the identifier is to be applied when the first function is at a top of the stack.

18. The computer-readable device of claim 16, wherein the rule specifies a second function and that the identifier is to be applied when the first function is called by the second function.
